(19) United States
(12) Patent Application Publication
(10) Pub. No.: US 2014/0269461 A1
(43) Pub. Date: Sep. 18, 2014

(54) SYSTEMS AND METHODS FOR LINK AUGMENTATION

(71) Applicant: QUALCOMM INCORPORATED, San Diego, CA (US)

(72) Inventor: Vipin Mehta, San Diego, CA (US)

(73) Assignee: QUALCOMM Incorporated, San Diego, CA (US)

(21) Appl. No.: 13/831,171

(22) Filed: Mar. 14, 2013

(51) Int. Cl. H04L 5/06

(52) U.S. Cl. CPC H04L 5/06
USPC 370/297

(57) ABSTRACT

Systems and methods are provided for coordinating operation of two or more WLAN subsystems in a single physical device to perform an operation more efficiently, such as with greater throughput. An existing communication link may be established between first WLAN subsystems of two wireless communications devices and augmented with an auxiliary link formed between second WLAN subsystems. A single data stream may be divided and a portion of the stream carried on each link.

### FIELD OF THE PRESENT DISCLOSURE

This disclosure generally relates to wireless communication systems and more specifically to systems and methods for increasing throughput.

### BACKGROUND

The proliferation of devices communicating using wireless local area networks (WLANs) has led to the development of devices that feature multiple, independent transceivers that allow simultaneous operations to occur over one or more frequency bands. Examples include dual band dual concurrent (DBDC) technologies that allow a device to operate under the Institute of Electrical and Electronics Engineers (IEEE) 802.11 standards simultaneously in the 2.4 and 5 GHz bands by using separate transceivers. As implied by the name, DBDC generally implies that both transceivers are capable of supporting both bands and are able to operate concurrently. Likewise, a single band dual concurrent device (SBDC) may employ two separate transceivers to allow simultaneous operation in either the 2.4 or 5 GHz band, depending upon the configuration chosen. Dual concurrent devices offer the capability to perform independent operations in parallel using the respective transceivers.

An advantage offered by a device capable of multiple concurrent operation is the potential to coordinate operation of two or more transceivers to perform a single operation more efficiently. For example, throughput has consistently been a performance indicator driving development of WLAN technology. The progression from WLAN protocols from 802.11b through 802.11 ac has been marked by ever increasing data rates. In addition to advances made at the physical (PHY) layer, changes in framing at the media access control (MAC) layer have also been made with a goal of increasing throughput. Such improvements have included the use of frame aggregation to reduce acknowledgement overhead. Techniques have also been developed to boost throughput by using concurrent transceivers, such as in the DBDC implementations discussed above. By using a capability known as fast channel switching (FCS), two or more DBDC devices in communication may coordinate a switch from a lower data rate using a first band to a higher data rate on a second band. The benefits of such techniques are mitigated, however, by overhead associated with the channel switching protocol.

Accordingly, it would desirable to coordinate operation of two or more WLAN subsystems to perform a single operation more efficiently, such as by increasing throughput. This disclosure achieves this and other goals.

### SUMMARY

This disclosure includes systems and methods for wireless communication. For example, a suitable wireless communications device may have a first wireless local area network (WLAN) subsystem to form a primary communication link with a first WLAN subsystem of a remote device, wherein the first WLAN subsystem has a first media access control (MAC), a first physical (PHY) layer and a first radio frequency (RF) layer, a second WLAN subsystem to form an auxiliary communication link with a second WLAN subsystem of the remote device wherein the second WLAN subsystem has a second MAC layer, a second PHY layer and a second RF layer, a diplexer to combine output from the first WLAN subsystem and the second WLAN subsystem for transmission and split a received signal into at least a first portion for the first WLAN subsystem and a second portion for the second WLAN subsystem, and an antenna to receive the combined output from the diplexer and transmit the combined output and receive the received signal and send the received signal to the diplexer. Further, the wireless communications device may have a data stream unit at a data link layer to receive a data stream from a network layer, wherein the data stream comprises a plurality of frames, the plurality of frames comprising a first set of frames and a second set of frames, route the first plurality of frames to the MAC layer of the first WLAN subsystem, and route the second portion to the MAC layer of the second WLAN subsystem. The data stream unit may sequentially identify the plurality of frames before routing the first portion and the second portion, such as by assigning sequence numbers from a global pool for each traffic class.

In one aspect, the data stream unit may route the first portion and the second portion of the plurality of frames using a Respective Channel Capacity (RCC) algorithm. In one embodiment, the data stream unit may route the first portion and the second portion in a ratio corresponding to the maximum channel width supported by the first WLAN subsystem to the maximum channel width supported by the second WLAN subsystem. In another aspect, the data stream unit may route the first portion and the second portion of the plurality of frames using a Combined Throughput Peak (CTP) algorithm. In one embodiment, the data stream unit may route the first portion and the second portion in an approximately 2:5 ratio when the first WLAN subsystem is a 2.4 GHz WLAN subsystem and the second WLAN subsystem is a 5 GHz WLAN subsystem.

In another aspect, the first WLAN subsystem may aggregate a first number of frames of the first portion for transmission and the second WLAN subsystem may aggregate a second number of frames for transmission, such that ratio of the frames corresponds to an operating region identified by the peak of the combined throughput. Further, the two WLAN subsystems may aggregate frames, such that a sum of the first number of frames and the second number of frames corresponds to a block acknowledgment window size.

In yet another aspect, the wireless communications device may include a link manager to enable or disable the auxiliary communication link based on a trigger. The trigger may be based on creation of the primary communication link, on bandwidth capacity of the primary communication link, on the rate at which the frames are being drained on the primary communication link, on an explicit user request, on link conditions including but not limited to packet error rate (PER), PHY rate from the rate adaptation algorithm, interference or congestion) or on the system power consumption, for example.

The disclosure also includes a wireless communications device that may have a first WLAN subsystem to form a primary communication link with a first WLAN subsystem of a remote device, wherein the first WLAN subsystem has a first MAC, a first PHY layer and a first RF layer, a second WLAN subsystem to form an auxiliary communication link with a second WLAN subsystem of the remote device wherein the second WLAN subsystem has a second MAC layer, a second PHY layer and a second RF layer, and a data stream unit at a data link layer to receive a first portion of a plurality of frames from the MAC layer of the first WLAN subsystem, to receive a second portion of a plurality of frames from the MAC layer of the second WLAN subsystem, and to combine the first portion and the second portion to form a data stream. The plurality of frames may include sequential identifiers and the data stream unit may form the data stream by ordering the plurality of frames based on the sequential identifiers. Further, the first WLAN subsystem and the second WLAN subsystem may send acknowledgement messages for received frames in a block acknowledgment window. In addition, the wireless communications device may have a network layer to receive the data stream formed by the data stream unit.

This disclosure also includes methods for wireless communication. For example, one embodiment may involve forming a primary communication link between a first WLAN subsystem of a transmitter device and a first WLAN subsystem of a receiver device, wherein the first WLAN subsystem of the transmitter device has a MAC layer, forming an auxiliary communication link between a WLAN subsystem radio of the transmitter device and a second WLAN subsystem of the receiver device, wherein the second WLAN subsystem of the transmitter device has a MAC layer, and splitting a data stream from a network layer comprising a plurality of frames, wherein a first portion of the plurality of frames are routed to the MAC layer of the first WLAN subsystem a second portion of the plurality of frames are routed to the MAC layer of the second WLAN subsystem. Splitting the data stream may also involve sequentially identifying the plurality of frames before routing the first portion and the second portion. Sequentially identifying the plurality of frames may include assigning sequence numbers from a global pool for each traffic class.

In one aspect, splitting the data stream may involve routing the first portion and the second portion of the plurality of frames using an RCC algorithm. The RCC algorithm may allocate the first portion and the second portion in a ratio corresponding to a maximum channel bandwidth of the first WLAN subsystem to a maximum channel bandwidth of the second WLAN subsystem.

In another aspect, splitting the data stream comprises routing the first portion and the second portion of the plurality of frames using a CTP algorithm. The CTP algorithm may route the first portion and a second portion such that the ratio of the first portion to the second portion corresponds to an operating region of a peak combined throughput. Further, the CTP algorithm may route the first portion and the second portion in an approximately 2:5 ratio if the first WLAN subsystem is operating using a maximum channel bandwidth of 40 MHz and a maximum modulation and coding scheme index of MCS8 and the second WLAN subsystem is operating with a maximum channel bandwidth of 80 MHz and a maximum modulation and coding scheme index of MCS9.

The method may also involve aggregating a first number of frames of the first portion for transmission by the first WLAN subsystem, such that the first number of frames corresponds to an operating region of increased throughput. In addition, a second number of frames of the second portion may be aggregated for transmission by the second WLAN subsystem, such that a sum of the first number of frames and the second number of frames corresponds to a block acknowledgment window size.

In a further aspect, the method may involve maintaining a queue to hold frames intended for at least one of the WLAN subsystems and frames for which acknowledgement is pending and removing frames from the queue for which acknowledgement is received, wherein a sequence of the frames in the queue may be non-contiguous.

In yet another aspect, the method may involve advancing a block acknowledgement window to accommodate a new frame when a pending frame identified for retransmission has not been received.

The method may also involve enabling or disabling the auxiliary communication link based, at least in part, on a trigger. The trigger may be at least one of creation of a primary communication link, destruction of a primary communication link, bandwidth capacity of a primary communication link, drain rate of a primary communication link, an explicit request from a user, or at least one link condition of a primary communication link, wherein link conditions comprise PER, interference, congestion, and PHY rate from a rate adaptation algorithm of one of the WLAN subsystems.

In a further aspect, the method may also involve receiving at least some of the first portion of the plurality of frames with the receiver device, receiving at least some of the second portion of the plurality of frames with the receiver device, and combining the received first portion and the received second portion to form a receive data stream. The plurality of frames include sequential identifiers, such that the receive data stream may be formed by ordering the received first portion and the received second portion based on the sequential identifiers. The frames may be ordered on a per traffic class basis. The receive data stream may also be coupled to a network layer of the receiver device.

### BRIEF DESCRIPTION OF THE DRAWINGS

Further features and advantages will become apparent from the following and more particular description of the preferred embodiments of the disclosure, as illustrated in the accompanying drawings, and in which like referenced characters generally refer to the same parts or elements throughout the views, and in which:

FIG. 1 schematically depicts a wireless communications system including a transmitter and a receiver operating over a primary communication link and an auxiliary communication link, according to one embodiment;

FIG. 2 schematically depicts functional blocks of a transmitter and a receiver capable of operating over a primary communication link and an auxiliary communication link, according to one embodiment;

FIG. 3 depicts data flow through upper layers and lower layers of a wireless communications protocol stack at a transmitter and a receiver operating over a primary communication link and an auxiliary communication link, according to one embodiment;

FIG. 4 is a graph depicting the relationship between throughput and aggregate size for TCP delivery over a primary communication link and an auxiliary communication link as compared to single communication link, according to one embodiment;

FIG. 5 is a graph depicting the relationship between throughput and aggregate size for UDP delivery over a primary communication link and an auxiliary communication link as compared to single communication link, according to one embodiment;

FIG. 6 is a flowchart showing an exemplary routine for transmitting a data stream over a primary communication link and an auxiliary communication link, according to one embodiment; and

FIG. 7 is a flowchart showing an exemplary routine for receiving a data stream over a primary communication link and an auxiliary communication link, according to one embodiment.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present invention and is not intended to represent the only exemplary embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

For purposes of convenience and clarity only, directional terms, such as top, bottom, left, right, up, down, over, above, below, beneath, rear, back, and front, may be used with respect to the accompanying drawings or particular embodiments. These and similar directional terms should not be construed to limit the scope of the disclosure in any manner and may change depending upon context. Further, sequential terms such as first and second may be used to distinguish similar elements, but may be used in other orders or may change also depending upon context.

Embodiments are described herein with regard to a wireless communications device, which may include any suitable type of user equipment, such as a system, subscriber unit, subscriber station, mobile station, mobile wireless terminal, mobile device, node, device, remote station, remote terminal, terminal, wireless communication device, wireless communication apparatus, user agent, or other client devices. Further examples of a wireless communications device include mobile devices such as a cellular telephone, cordless telephone, Session Initiation Protocol (SIP) phone, smart phone, wireless local loop (WLL) station, personal digital assistant (PDA), laptop, handheld communication device, handheld computing device, satellite radio, wireless modem card and/or another processing device for communicating over a wireless system. Moreover, embodiments may also be described herein with regard to an access point (AP). An AP may be utilized for communicating with one or more wireless nodes and may be termed also be called and exhibit functionality associated with a base station, node, Node B, evolved NodeB (eNB) or other suitable network entity. An AP communicates over the air-interface with wireless terminals. The communication may take place through one or more sectors. The AP may act as a router between the wireless terminal and the rest of the access network, which may include an Internet Protocol (IP) network, by converting received air-interface frames to IP packets. The AP may also coordinate management of attributes for the air interface, and may also be the gateway between a wired network and the wireless network.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

Included in this specification are techniques for communicating between two wireless communications devices, each having at least two WLAN subsystems with MAC, PHY and RF blocks capable of operating concurrently. By coordinating operation of two or more WLAN subsystems at each device, a single operation may be performed more efficiently, such as with greater throughput. In one aspect, a primary communication link established between first WLAN subsystem of two wireless communications devices may be augmented with an auxiliary communication link formed between second WLAN subsystem. Rather than operating independently, a single data stream may be divided and a portion of the stream carried on each link.

To help illustrate the systems and methods of this disclosure, an exemplary wireless communication system 100 is shown in FIG. 1, including a first wireless communications device, such as transmitter 102, and a second wireless communications device, such as receiver 104. Generally, the wireless communications devices may be configured with two or more WLAN subsystems and correspondingly may be capable of both transmission and reception. For example, the wireless communications devices may be DBDC devices, SBDC devices, or other configurations having multiple concurrent capabilities. However, for clarity, the following discussion is provided in the context of transmitter 102 being the source for a data stream which is sent over the wireless medium and receiver 104 being the sink for the data stream and the devices are identified by those roles. Again, for clarity, the transmitter and receiver consist of two WLAN subsystems each with one WLAN subsystem operating in the, e.g., 2.4 GHz band and the other WLAN subsystem operating in the, e.g., 5 GHz band. As shown, transmitter 102 may form a primary communication link 106 with receiver 104. Further, according to the techniques of this disclosure, an auxiliary communication link 108 may be formed between transmitter 102 and receiver 104. By delivering a data stream over both primary communication link 106 and auxiliary communication link 108, greater throughput may be realized as compared to use of primary communication link 106 alone. For example, the bandwidth represented by the virtual link that includes both primary communication link 106 and auxiliary communication link 108 may be approximately equal to the bandwidth of primary communication link 106 plus the bandwidth of auxiliary communication link 108.

Additional details regarding one embodiment of transmitter 102 and receiver 104 are depicted as high level schematic blocks in FIG. 2. Generally, transmitter 102 and receiver 104 may employ architectures in which the lower levels of the WLAN protocol stack are implemented in firmware and hardware of respective WLAN subsystems. As shown, transmitter 102 may include a first WLAN subsystem 202 having a media access controller (MAC) 204 that performs functions related to the handling and processing of 802.11 frames of data including verification, acknowledgment, routing, formatting and the like. Incoming and outgoing frames are exchanged between MAC 204 and physical layer (PHY) 206, which as shown here includes the functions of modulating the frames according to the relevant 802.11 protocol to allow transmission at a data rate corresponding to the modulation and coding scheme (MCS) employed, which may be determined using an appropriate rate adaptation algorithm, for example. Radio frequency block (RF) 207 provides the analog processing necessary to provide transmission and reception of wireless signals. Further, transmitter 102 may also include a second WLAN subsystem 208 having equivalent MAC 210, PHY 212 and RF 213 blocks.

In the depicted embodiment, the output from the first WLAN subsystem 202 and second WLAN subsystem 208 is combined through Diplexer 214 and fed into antenna 216. As desired and depending upon other wireless protocols employed, one or more antennas may be shared between additional WLAN subsystems using switching techniques known in the art. Likewise, some or all elements of the respective WLAN subsystems may be co-located on a common system (e.g., on the same circuit board or on distinct circuit boards within the same system, or may be embedded on the same integrated circuit as in a system on a chip (SoC) implementation).

Transmitter 102 also includes host CPU 218 configured to perform the various computations and operations involved with the functioning of transmitter 102, including the functionality associated with the upper layers of the WLAN protocol stack, as noted above. Host CPU 218 is coupled to first WLAN subsystem 202 and second WLAN subsystem 208 through bus 220, which may be implemented as a peripheral component interconnect express (PCIe) bus, a universal serial bus (USB), a universal asynchronous receiver/transmitter (UART) serial bus, a suitable advanced microcontroller bus architecture (AMBA) interface, a serial digital input output (SDIO) bus, or other equivalent interface. Memory 222 may be coupled to bus 220 to store transmitted and received information and processor-readable instructions, such as software, related to operation of host CPU 218. As shown, transmitter 102 may include data stream unit 224 to route information from the upper layers of the WLAN protocol stack, for example by receiving output from the internet protocol (IP) layer in the form of a plurality of frames of data. When the auxiliary communication link is enabled for link augmentation, data stream unit 224 routes each frame of the plurality of frames received from the IP layer to either MAC layer 204 of first WLAN subsystem 202 or MAC layer 210 of second WLAN subsystem 208. As desired, data stream unit 224 may be implemented in software, such as in the form of instructions stored in memory 222, in firmware, in hardware, or in any combination thereof.

Receiver 104 may be similarly configured to perform a reciprocal process following reception of the plurality of frames sent by transmitter 102. As shown, receiver 104 may also include first WLAN subsystem 226 having MAC 228, PHY 230 and RF 231 blocks and second WLAN subsystem 232 having MAC 234, PHY 236 and RF 237 blocks, feeding Diplexer 238 and associated antenna 240. Likewise, receiver 104 includes host CPU 242 coupled by bus 244 to memory 246, first WLAN subsystem 226 and second WLAN subsystem 232. Receiver 104 may also include data stream unit 248 to route information received from MAC 228 and MAC 234 to the upper layers of the WLAN protocol stack. As will be described below, data stream unit 248 may reconstitute the plurality of frames into a data stream corresponding to the one received by data stream unit 224.

A schematic representation of the data flow from transmitter 102 to receiver 104 is illustrated in FIG. 3. A data stream, such as one sourced at application layer 302, may flow through a transport layer, such as either transport control protocol (TCP) layer 304 or universal datagram protocol (UDP) layer 306 as desired, depending upon factors such as the type of traffic, the use case and the application involved. Frames of information are then generated at a network layer, e.g., IP layer 308, such as in the IEEE 802.3 Ethernet format. The frames are translated to an IEEE 802.11 format in frame translation block 310 and fed to data stream unit 224. As shown, data stream unit 224 may include a sequence number assignment block 312 to sequentially identify the plurality of frames in the data stream being output by IP layer 308. Under operation of link manager 314, data stream splitter 316 may be configured to route frames either to the primary communication link through MAC 204, PHY 206 and RF 207 or to the auxiliary communication link through MAC 210, PHY 212 and RF 213 when the auxiliary link is enabled. The frames may be assigned to the primary or auxiliary communication link based on any suitable algorithm, depending upon the desired level of performance, the use case, or other variable. As will be described below, the algorithm may be configured to accommodate a desired (e.g., the maximum) channel capacities supported by the respective WLAN subsystems or it may be based on the peak aggregated throughput to provide performance enhancement. When the auxiliary communication link is disabled, data stream splitter 316 may route all frames directly to the primary communication link.

As noted, a reciprocal process may occur at receiver 104. The plurality of frames are shown to be received by RF 231, PHY 230 and MAC 228 of the primary communication link or by RF 237, PHY 236 and MAC 234 of the auxiliary communication link, depending upon the WLAN subsystem of transmitter 102 used to send the frame. The plurality of frames are combined and reordered as necessary to reconstruct the data stream by data stream unit 248. Each frame output by MAC 228 and MAC 234 is joined into a receive data stream by data stream combiner 318 under control of link manager 320. Data stream combiner 318 may implement the logic to combine the portions of the data stream coming over the primary and auxiliary communication link into one receive data stream to be reordered. Because the frames may arrive at receiver 104 at different times or may fail and require retransmission, the receive data stream output by data stream combiner 318 may include frames that are out of sequence. Accordingly, sequence reordering block 322 may use the sequential identifiers assigned in sequence number assignment block 312 to reconstruct and output the plurality of frames in the correct sequence. The reconstructed plurality of frames representing the transmitted data stream then flow to frame translation block 324 to be converted from, e.g., 802.11 format to 802.3 format. The plurality of frames may then travel through the upper layers of the WLAN protocol stack, through IP layer 326, TCP layer 328 or UDP layer 330 as appropriate, and sink to application layer 332.

In one embodiment, sequence number assignment block 312 may sequentially identify the plurality of frames output by IP layer 308 by maintaining global pools of sequence numbers. For example, a global pool of numbers may be provided for each traffic class identification for each station. The plurality of frames for each data stream may be given a number from the global pool corresponding to its order within the stream. The sequence number may then be used to reorder the plurality of frames by sequence reordering block 322. In this manner, frames arriving over either the primary communication link or the auxiliary communication link may of be reordered into a single output from data stream unit 248 corresponding to the stream that was fed into data stream unit 224.

During the reordering process, sequence reordering block 322 may utilize the sequence numbers in reconstructing the data stream. In one aspect, sequence reordering block 322 may be configured to perform an inter link reordering process such that frames arriving over the primary communication link and the auxiliary communication link may be placed in the correct sequence with regard to each other. In another aspect, sequence reordering block 322 may be configured to perform an intra link reordering process such that frames arriving over each communications link may be placed in the correct sequence with regard to the other frames arriving over that communications link. For example, frames to be transmitted may be processed by MAC 204 or MAC 210 to form an aggregate frame transmission over one of the physical links.

When employing a wireless protocol such as an IEEE 802.11 standard, transmissions may be organized into discrete units of information. Information is packetized at an upper level of the wireless protocol stack, such as the network layer. As the information is passed to the data link layer, the packets or datagrams may be organized into frames having a defined format. In one aspect, information received at the MAC sublayer of the data link layer may be organized in MAC service data units (MSDUs). The MAC layer may wrap each MSDU in a MAC header to form a MAC protocol data unit (MPDU) that is delivered to the physical (PHY) layer. In turn, the PHY layer wraps the MPDU in a PHY layer convergence protocol (PLCP) header to form a PLCP protocol data unit (PPDU) which may be modulated and transmitted over the wireless medium. To reduce the framing overhead, multiple frames may be aggregated into a single wrapper. At the MSDU level, multiple MSDU frames may be grouped to form an aggregate MSDU (A-MSDU), which may then be wrapped with a single MPDU header. Similarly, at the MPDU level, multiple MPDU frames may be grouped to form an aggregate MPDU (A-MPDU), requiring only one PCLP header. Accordingly, the aggregation of frames reduces the number of protocol headers and leads to a decrease in overhead. Under current standards, an A-MPDU may contain 64 MPDUs, although the techniques of this disclosure are not limited in this respect.

In response, a receiving station may transmit an acknowledgement (ACK) for each MPDU successfully received. To accommodate the multiple frames transmitted in an aggregate frame, the receiving stations may employ a block acknowledgement (BA) process. Rather than transmitting an individual ACK for every frame, the success or failure of multiple frames addressed to a given station may be acknowledged with a BA frame, having a bitmap indicating the success or failure of reception of each frame. The MAC layer of the transmitter employ the ACK and BA communications to identify frames that were not successfully received and may require retransmission.

Further, the BA window size supported by receiver 104 may impact the maximum size of the aggregate frame that can be supported in the primary and auxiliary communication links. Similarly, the BA window size may also impact the maximum throughput achievable over the physical link. Each WLAN subsystem 202 and 208 may therefore include frame retransmission logic, e.g., implemented in MAC 204 and 210, respectively. The frame retransmission logic may maintain a queue to store frames that are pending to be sent to the WLAN subsystems on the receiver 226 and 232. The two queues may store the portion of frames meant for 202 and 208 respectively and the frames for which no acknowledgement has been received from 226 and 232 respectively either because the original frames are lost/corrupted or because the ACK is lost/corrupted. As and when the acknowledgement is received by 226 and 232, the queues remove the corresponding frames. As a consequence of splitting the data stream and retransmitting the unacknowledged frames, frames sent by each WLAN subsystem 202 and 208 may have discontinuities or frames that are out of order. The frames remaining in the queue may not be contiguous but may represent gaps in the sequence of frames that have arrived at receiver 104 WLAN subsystems 226 and 232 in the receiver 104 may set the bits in their respective BA bitmask to ‘1’ to identify successfully received frames, which may then be removed from the queue when each WLAN subsystem 202 and 208 processes acknowledgments sent for any transmitted frames. When each transmitter 202 and 208 processes the received acknowledgements, the frames remaining in the queues that have not been acknowledged may be aggregated with additional incoming frames for transmission, allowing the missed frames to be retransmitted. In turn, receiver 104 may plug any gaps in the receive data stream once WLAN subsystems 226 and 232 successfully process any retransmitted frames. If any frames are still missing, receiver 104 may send another notification for any frames within the BA window. The BA window may have a predetermined size, such that the window advances to accommodate newly transmitted frames and any gaps that are not filled may be ignored once the window has moved beyond them. As desired, error correction mechanisms implemented at higher layers may be used to compensate for such losses.

By employing the above techniques, MAC layers 204 and 210 may perform processing in compliance with the IEEE 802.11 protocol being employed for each portion of the plurality of frames assigned to them by data stream unit 224. For example, one suitable sequence of processing operations applied to the incoming frames may include any combination of aggregation into A-MSDU frames, deferral queuing to implement a power save routine, fragmentation, MPDU encryption and integrity, wrapping of MPDU frames with header and error check sequences and aggregation into A-MPDU frames.

Link managers 314 and 320 may be responsible for creating, deleting and maintaining the primary and auxiliary communication links between transmitter 102 and receiver 104. Formation of the primary communication link 106 may follow conventional IEEE 802.11 authentication and association routines. Once established, transmitter 102 and receiver 104 may advertise or otherwise provide notification of link augmentation capabilities to allow operation according to the techniques of this disclosure. In one aspect, transmitter 102 and receiver 104 may exchange management frames having an information element carrying relevant parameters associated with link augmentation, including supported data stream splitting algorithms. Auxiliary communication link 108 may also be configured to share relevant settings with primary communication link 106 to reduce association overhead. For example, auxiliary communication link 108 may inherit properties from primary communication link 106 including security, MAC parameters, and the like.

In one aspect, with respect to transmitter 102, link manager 314 may include suitable logic to initiate formation of the auxiliary link based upon one or more desired criteria. In one embodiment, primary communication link 106 may persist for the period in which transmitter 102 and receiver 104 are associated and auxiliary communication link 108 may be enabled and disabled in response to one or more triggers events or conditions as desired. Upon determination of a suitable trigger, link manager 314 may cause an exchange of management frames associated with establishing the auxiliary communication link 108. Once established, data stream unit 224 may split the plurality of frames received from IP layer 308 so that they are transmitted over both primary communication link 106 and auxiliary communication link 108. One suitable trigger includes the establishment of primary communication link 106. To provide maximum throughput, auxiliary communication link 108 may be enabled whenever primary communication link 106 is established. Another suitable trigger may be based, at least in part, on an operating condition. For example, if the bandwidth of primary communication link 106 is close to saturation, auxiliary communication link 108 may be enabled. Another trigger may be based, at least in part, on the rate at which the frames are being drained (e.g., if the rate falls below a specific threshold because of deteriorating channel conditions). A trigger may also be based, at least in part, on an explicit user request (which, e.g., may be based on the broader state of the system). A trigger may also be based, at least in part, on link conditions including, but not limited to, Packet Error Rate (PER), Interference, Congestion and the PHY rate from the Rate Adaptation algorithm. Yet another trigger may be based, at least in part, on the Power Consumption threshold. For example, if a mobile device, e.g., a phone) is running low on battery or is charged beyond a specific threshold, the auxiliary link can be disabled or enabled, respectively.

Link manager 314 may also include logic associated with disabling auxiliary communication link 108, which may also be controlled by suitable triggers. For example, auxiliary communication link 108 may be torn down when primary communication link 106 is disabled or when bandwidth utilization of primary communication link 106 falls below a threshold. The triggers could be based, at least in part, on the conditions reciprocal to conditions mentioned below for enabling the auxiliary link.

As discussed above, the performance achieved while employing the link augmentation techniques of this disclosure may depend in part on the algorithm used by data stream splitter 316 to assign the plurality of frames to either WLAN subsystem 202 or WLAN subsystem 208. In one aspect, the data stream splitting can be based, at least in part, on the Respective Channel Capacity (RCC) algorithm, wherein the data stream unit routes the first portion and the second portion of the plurality of frames in a ratio corresponding to the maximum channel bandwidth of the first WLAN subsystem to the maximum channel bandwidth of the second WLAN subsystem, as will be described later. In another aspect, the data stream splitting can be based, at least in part, on the Combined Throughput Peak (CTP) algorithm wherein the data stream unit routes the first portion and the second portion of the plurality of frames in a ratio that maximizes the combined throughput, as will be described later.

To provide an illustration of representative factors that may influence the data stream splitting algorithm and other parameters of the link augmentation technique, FIG. 4 is a graph showing the relationship between throughput and A-MPDU aggregation size. The depicted results were obtained by modeling TCP throughput over 2.4 GHz and 5 GHz communications links. The modulation and coding scheme (MCS) Index for the 5 GHz link was 9 and for the 2.4 GHz link, the MCS was 8. Channel width for the 5 GHz link was 80 MHz and channel width for the 2.4 GHz link was 40 MHz. A guard interval of 0.4 μs was modeled, along with a transmit opportunity limit of 4048 μs. The TCP packet size was 1460 bytes and the TCP ACK size was 48 bytes. A minimum contention window size was modeled to be 15 slots and a maximum contention window size was modeled to be 1023 slots, with an assumed collision probability of 11%. MSDU frames were not aggregated and MPDUs were aggregated into A-MPDUs ranging from 1 to 64 subframes. The BA was compressed. The above conditions and assumptions are to be taken as representative only. Other modeling assumptions may be employed as desired or may be based on use cases or empirical observations.

The graph shown in FIG. 4 includes curves corresponding to link augmentation using primary and auxiliary communication links comprised of two 2.4 GHz channels as depicted by curve 402, one 2.4 GHz channel and one 5 GHz channel as depicted by curve 404 and two 5 GHz channels as depicted by curve 406. For reference, throughput using a single 2.4 GHz channel without link augmentation is depicted by curve 408 and using a single 5 GHz channel without link augmentation is depicted by curve 410. As shown, throughput may be greater when using aggregate sizes less than the maximum allowed. An operating region may be identified for each combination corresponding to a desired level of a characteristic, such as increased throughput. Operating region 412 indicates A-MPDU aggregate sizes of approximately 27 to 37 result in maximized throughput levels for the two 2.4 GHz channel configuration, operating region 414 indicates A-MPDU aggregate sizes of approximately 40 to 50 result in maximized throughput levels for the 2.4 GHz channel and 5 GHz channel configuration, and operating region 416 indicates A-MPDU aggregate sizes of approximately 27 to 37 result in maximized throughput levels for the two 5 GHz channel configuration. In comparison, the use of a single 2.4 GHz or 5 GHz channel results in maximized throughput regions 418 and 420, respectively, at the maximum aggregate size of 64.

Further, FIG. 4 illustrates that by employing the techniques of this disclosure a gain in throughput may be achieved. Link augmentation results in a gain of approximately 33% for a 2.4 GHz channel and 5 GHz channel configuration relative to use of a 5 GHz channel alone as indicated by delta 422 and a gain of approximately 74% for a two 5 GHz channel configuration relative to a 5 GHz channel alone as indicated by delta 424.

In another example, similar operating conditions were modeled for a UDP transfer. UDP packet size was 1472 bytes and, consistent with the protocol, no acknowledgment was performed and the transport layer. All other conditions and assumption were the same. The results showing throughput in relation to A-MPDU aggregate size are depicted in FIG. 5. Curves corresponding to link augmentation using primary and auxiliary communication links include curve 502, which corresponds to two 2.4 GHz channels, curve 504, which corresponds to one 2.4 GHz channel and one 5 GHz channel, and curve 506, which corresponds to two 5 GHz channels. Again, throughput using a single 2.4 GHz channel without link augmentation is depicted by curve 508 and using a single 5 GHz channel without link augmentation is depicted by curve 510 for reference. Operating regions at which throughput may be maximized by using aggregate sizes less than the maximum allowed may be identified for the link augmentation curves. Operating region 512 indicates A-MPDU aggregate sizes of approximately 27 to 37 result in maximized throughput levels for the two 2.4 GHz channel configuration, operating region 514 indicates A-MPDU aggregate sizes of approximately 40 to 50 result in maximized throughput levels for the 2.4 GHz channel and 5 GHz channel configuration, and operating region 516 indicates A-MPDU aggregate sizes of approximately 27 to 37 result in maximized throughput levels for the two 5 GHz channel configuration. As in the TCP example of FIG. 4, the use of a single 2.4 GHz or 5 GHz channel results in maximized throughput regions 518 and 520, respectively, at the maximum aggregate size of 64. As shown, following the link augmentation techniques of this disclosure may result in a gain of approximately 35% for a 2.4 GHz channel and 5 GHz channel configuration relative to a 5 GHz channel alone as indicated by delta 522 and a gain of approximately 81% for a two 5 GHz channel configuration relative to a 5 GHz channel alone as indicated by delta 524.

Based on the aggregate sizes corresponding to the respective operating regions, aggregate sizes for A-MPDUs sent over primary communication link 106 and auxiliary communication link 108 may be determined. If the BA window is set to 64 to correspond to a maximum A-MPDU of 64 subframes, aggregate size for one channel may be based on the determined operating regions and aggregate size for the other channel may correspond to the remaining space in the BA window. For example, when employing link augmentation using the different bands for primary communication link 106 and auxiliary communication link 108, the results in FIGS. 4 and 5 (e.g., operating region 414 and operating region 514) indicate that throughput is close to maximum at aggregate sizes between 40 and 50, such that the 5 GHz channel may be configured to employ an aggregate size in this range and the 2.4 GHz link may be configured to employ an aggregate size in the complementary range of 24 through 14. In another example, when employing link augmentation using the same band for primary communication link 106 and auxiliary communication link 108, the results in FIGS. 4 and 5 (e.g., operating region 412 and operating region 512 or operating region 416 and operating region 516) indicate that throughput is close to maximum at aggregate sizes between 27 and 37, such that one channel may be configured to employ an aggregate size in this range and the other channel may be configured to employ an aggregate size in the complementary range of 37 through 27.

In another aspect, the algorithm employed by data stream splitter 316 may be selected to provide desired performance characteristics. The throughput achieved using the link augmentation techniques of this disclosure may depend upon the algorithm used. In one embodiment, the algorithm may be based on the channel capacity as represented by the bandwidths of primary communication link 106 and auxiliary communication link 108 using an RCC algorithm. For example, a 2.4 GHz channel may have a bandwidth of 40 MHz and a 5 GHz channel may have a bandwidth of 80 MHz. Accordingly, data stream splitter 316 may assign the plurality of frames in a 1:2 ratio to match the channel capacities. The plurality of frames may be identified with sequence numbers from 1 to 4096, such that frames having the sequence numbers 3n+i, wherein n=0, 1, 2 . . . 1364 and i=1, 2, are routed to the 5 GHz channel and frames having the sequence number 3n, wherein n=0, 1, 2 . . . 1364, are routed to the 2.4 GHz channel. Correspondingly, when employing the same band for primary communication link 106 and auxiliary communication link 108, such as either the 2.4 GHz band or the 5 GHz band, each link may have the same capacity and the frames may be assigned in a 1:1 ratio. The plurality of frames may be identified with sequence numbers from 1 to 4096, such that frames having the sequence numbers 2n, wherein n=0, 1, 2 . . . 2047, are routed to one channel and frames having the sequence number 2n+1, wherein n=0, 1, 2 . . . 2047, are routed to the other channel.

In another embodiment, the algorithm may be based on operating in the region of peak aggregated throughput using a CTP algorithm. Based on models such as those depicted in FIGS. 4 and 5 or other suitable information, a suitable ratio may be determined to increase throughput. For example, when employing a 2.4 GHz channel and a 5 GHz channel, throughput has been found to be increased when frames are allocated between the channels in a 19:45 ratio. This may be approximated to a ratio of 2:5 while obtaining similar results. Accordingly, data stream splitter 316 may identify the plurality of frames with sequence numbers from 1 to 4096, such that frames having the sequence numbers 7n+i, wherein n=0, 1, 2 . . . 584 and i=1, 2 . . . 5, are routed to the 5 GHz channel and frames having the sequence number 7n+5+i, wherein n=0, 1, 2 . . . 584 and i=1, 2, . . . 5, are routed to the 2.4 GHz channel. When employing the same band for primary communication link 106 and auxiliary communication link 108, such as either the 2.4 GHz band or the 5 GHz band, each link may have the same capacity and the frames may be assigned in a 1:1 ratio. The plurality of frames may be identified with sequence numbers from 1 to 4096, such that frames having the sequence numbers 2n, wherein n=0, 1, 2 . . . 2047, are routed to one channel and frames having the sequence number 2n+1, wherein n=0, 1, 2 . . . 2047, are routed to the other channel.

To help illustrate the techniques of this disclosure with regard to transmitting a data stream over primary communication link 106 and auxiliary communication link 108, FIG. 6 depicts a flow chart representing one exemplary routine. Beginning with 602, primary communication link 106 may be formed between two wireless communications devices, such as transmitter 102 and receiver 104. Based on a suitable trigger, link manager 314 may enable auxiliary communication link 108 between transmitter 102 and receiver 104 in 604. The plurality of frames of a data stream output by IP layer 308 may be sequentially identified by sequence number assignment block 312 as represented by 606. Data stream splitter 316 may split the data stream in 608 such that a first portion of frames are routed to MAC layer 204 of first WLAN subsystem 202 and a second portion of frames are routed to MAC layer 210 of second WLAN subsystem 208. Then, first WLAN subsystem 202 and second WLAN subsystem 208 may retransmit any frames of the first portion and the second portion in a block acknowledgement window that are not acknowledged in 610.

A corresponding exemplary routine with regard to regard to receiving a data stream over primary communication link 106 and auxiliary communication link 108 is represented by the flow chart depicted in FIG. 7. Beginning with 702, primary communication link 106 and auxiliary communication link 108 may be formed between two wireless communications devices, such as transmitter 102 and receiver 104. Transmitter 102 may send a data stream that has been split such that at least some of a first portion of frames transmitted by first WLAN subsystem 202 are received by first WLAN subsystem 226 and at least some of a second portion of frames transmitted by second WLAN subsystem 208 are received by second WLAN subsystem 232 in 704. Next, first WLAN subsystem 226 and second WLAN subsystem 232 may send acknowledgment messages with regard to the received first portion of frames and the received second portion of frames within a block acknowledgment window in 706. In response to the acknowledgment messages, transmitter 102 may retransmit non-acknowledged frames in 708. As a result, receiver 104 may receive any retransmitted frames such that data stream unit 246 may form a receive data stream by ordering the received first portion of frames and the received second portion of frames and inserting any retransmitted non-acknowledged frames with sequence reordering block 322 in 710. The receive data stream may be coupled to IP layer 326 for delivery of the data stream to application layer 332.

Described herein are presently preferred embodiments. However, one skilled in the art will understand that the principles of this disclosure can be extended easily with appropriate modifications to other applications.

What is claimed is:

1. A wireless communications device comprising:
a first wireless local area network (WLAN) subsystem to form a primary communication link with a first WLAN subsystem of a remote device, wherein the first WLAN subsystem has a first media access control (MAC), a first physical (PHY) layer and a first radio frequency (RF) layer;
a second WLAN subsystem to form an auxiliary communication link with a second WLAN subsystem of the remote device wherein the second WLAN subsystem has a second MAC layer, a second PHY layer and a second RF layer;
a diplexer to:
combine output from the first WLAN subsystem and the second WLAN subsystem for transmission; and
split a received signal into at least a first portion for the first WLAN subsystem and a second portion for the second WLAN subsystem; and
an antenna to:
receive the combined output from the diplexer and transmit the combined output; and
receive the received signal and send the received signal to the diplexer.

2. The wireless communications device of claim 1 comprising a data stream unit at a data link layer to:
receive a data stream from a network layer, wherein the data stream comprises a plurality of frames, the plurality of frames comprising a first set of frames and a second set of frames,
route the first plurality of frames to the MAC layer of the first WLAN subsystem, and
route the second portion to the MAC layer of the second WLAN subsystem.

3. The wireless communications device of claim 2, wherein the data stream unit to sequentially identify the plurality of frames before routing the first portion and the second portion.

4. The wireless communications device of claim 3, wherein the data stream unit to sequentially identify the plurality of frames by assigning sequence numbers from a global pool for each traffic class.

5. The wireless communications device of claim 2, wherein the data stream unit to route the first portion and the second portion of the plurality of frames using a Respective Channel Capacity (RCC) algorithm.

6. The wireless communications device of claim 5, wherein the data stream unit to route the first portion and the second portion in a ratio corresponding to a maximum channel bandwidth of the first WLAN subsystem to a maximum channel bandwidth of the second WLAN subsystem.

7. The wireless communications device of claim 2, wherein the data stream unit to route the first portion and the second portion of the plurality of frames using a Combined Throughput Peak (CTP) algorithm.

8. The wireless communications device of claim 7, wherein the data stream unit to route the first portion and a second portion such that the ratio of the first portion to the second portion corresponds to an operating region of a peak combined throughput.

9. The wireless communications device of claim 8, wherein the data stream unit to route the first portion and the second portion in an approximately 2:5 ratio if the first WLAN subsystem is operating using a maximum channel bandwidth of 40 MHz and a maximum modulation and coding scheme index of MCS8 and the second WLAN subsystem is operating with a maximum channel bandwidth of 80 MHz and a maximum modulation and coding scheme index of MCS9.

10. The wireless communications device of claim 2, wherein the data stream unit further to aggregate a first number of frames of the first portion for transmission by the first WLAN subsystem, such that the first number of frames corresponds to an operating region of increased throughput.

11. The wireless communications device of claim 10, wherein the data stream unit further to aggregate a second number of frames of the second portion for transmission by the second WLAN subsystem, such that a sum of the first number of frames and the second number of frames corresponds to a block acknowledgment window size.

12. The wireless communications device of claim 1, wherein at least one of the WLAN subsystems includes frame retransmission logic to:
maintain a queue to hold frames intended for the WLAN subsystem and frames for which acknowledgement is pending; and
remove frames from the queue for which acknowledgement is received, wherein a sequence of the frames in the queue may be non-contiguous.

13. The wireless communications device of claim 1, further comprising a link manager to enable or disable the auxiliary communication link based, at least in part, on a trigger.

14. The wireless communications device of claim 12, wherein the trigger is at least one of the group consisting of:
creation of a primary communication link;
destruction of a primary communication link;
bandwidth capacity of a primary communication link;
drain rate of a primary communication link;
an explicit request from a user; and
at least one link condition of a primary communication link, wherein link conditions comprise packet error rate (PER), interference, congestion, and PHY rate from a rate adaptation algorithm of one of the WLAN subsystems.

15. The wireless communications device of claim 1, further comprising a data stream unit at a data link layer to:
receive a first portion of the original data stream from the first WLAN subsystem;
receive a second portion of the original data stream from the second WLAN subsystem; and
combine the received first portion and the received second portion to generate the original data stream.

16. A wireless communications device comprising:
a first wireless local area network (WLAN) subsystem to form a primary communication link with a first WLAN subsystem of a remote device, wherein the first WLAN subsystem has a first media access control (MAC), a first physical (PHY) layer and a first radio frequency (RF) layer;
a second WLAN subsystem to form an auxiliary communication link with a second WLAN subsystem of the remote device wherein the second WLAN subsystem has a second MAC layer, a second PHY layer and a second RF layer; and
a data stream unit at a data link layer to receive a first portion of a plurality of frames from the MAC layer of the first WLAN subsystem, to receive a second portion of a plurality of frames from the MAC layer of the second WLAN subsystem, and to combine the first portion and the second portion to form a data stream.

17. The wireless communications device of claim 16, wherein the plurality of frames include sequential identifiers and wherein the data stream unit to form the data stream by ordering the plurality of frames based on the sequential identifiers.

18. The wireless communications device of claim 16, wherein the first WLAN subsystem and the second WLAN subsystem to send acknowledgement messages for received frames in a block acknowledgment window.

19. The wireless communications device of claim 16, further comprising an network layer to receive the data stream formed by the data stream unit.

20. A method for wireless communication, comprising:
forming a primary communication link between a first WLAN subsystem of a transmitter device and a first WLAN subsystem of a receiver device, wherein the first WLAN subsystem of the transmitter device has a media access control (MAC) layer;
forming an auxiliary communication link between a WLAN subsystem radio of the transmitter device and a second WLAN subsystem of the receiver device, wherein the second WLAN subsystem of the transmitter device has a MAC layer; and
splitting a data stream from a network layer comprising a plurality of frames, wherein a first portion of the plurality of frames are routed to the MAC layer of the first WLAN subsystem a second portion of the plurality of frames are routed to the MAC layer of the second WLAN subsystem.

21. The method of claim 20, wherein splitting the data stream further comprises sequentially identifying the plurality of frames before routing the first portion and the second portion.

22. The method of claim 21, wherein sequentially identifying the plurality of frames comprises assigning sequence numbers from a global pool for each traffic class.

23. The method of claim 22, wherein splitting the data stream comprises routing the first portion and the second portion of the plurality of frames using a Respective Channel Capacity (RCC) algorithm.

24. The method of claim 23, wherein the RCC algorithm allocates the first portion and the second portion in a ratio corresponding to a maximum channel bandwidth of the first WLAN subsystem to a maximum channel bandwidth of the second WLAN subsystem.

25. The method of claim 20, wherein splitting the data stream comprises routing the first portion and the second portion of the plurality of frames using a Combined Throughput Peak (CTP) algorithm.

26. The method of claim 25, wherein the CTP algorithm routes the first portion and a second portion such that the ratio of the first portion to the second portion corresponds to an operating region of a peak combined throughput.

27. The method of claim 26, wherein the CTP algorithm routes the first portion and the second portion in an approximately 2:5 ratio if the first WLAN subsystem is operating using a maximum channel bandwidth of 40 MHz and a maximum modulation and coding scheme index of MCS8 and the second WLAN subsystem is operating with a maximum channel bandwidth of 80 MHz and a maximum modulation and coding scheme index of MCS9.

28. The method of claim 20, further comprising aggregating a first number of frames of the first portion for transmission by the first WLAN subsystem, such that the first number of frames corresponds to an operating region of increased throughput.

29. The method of claim 28, further comprising aggregating a second number of frames of the second portion for transmission by the second WLAN subsystem, such that a sum of the first number of frames and the second number of frames corresponds to a block acknowledgment window size.

30. The method of claim 20, further comprising maintaining a queue to hold frames intended for at least one of the WLAN subsystems and frames for which acknowledgement is pending and removing frames from the queue for which acknowledgement is received, wherein a sequence of the frames in the queue may be non-contiguous.

31. The method of claim 20, further comprising advancing a block acknowledgement window to accommodate a new frame when a pending frame identified for retransmission has not been received.

32. The method of claim 20, further comprising enabling or disabling the auxiliary communication link based, at least in part, on a trigger.

33. The method of claim 32, wherein the trigger is at least one of the group consisting of:
creation of a primary communication link;
destruction of a primary communication link;
bandwidth capacity of a primary communication link;
drain rate of a primary communication link;
an explicit request from a user; and
at least one link condition of a primary communication link, wherein link conditions comprise Packet Error Rate (PER), Interference, Congestion, and PHY rate from a Rate Adaptation algorithm of one of the WLAN subsystems.

34. The method of claim 20, further comprising;
receiving at least some of the first portion of the plurality of frames with the receiver device;
receiving at least some of the second portion of the plurality of frames with the receiver device; and
combining the received first portion and the received second portion to form a receive data stream.

35. The method of claim 34, wherein the plurality of frames include sequential identifiers, further comprising forming the receive data stream by ordering the received first portion and the received second portion based on the sequential identifiers.

36. The method of claim 35, wherein forming the receive data stream further comprises ordering the frames on a per traffic class basis.

37. The method of claim 34, further comprising coupling the receive data stream to a network layer of the receiver device.
